(19) United States
(12) Patent Application Publication
(10) Pub. No.: US 2012/0261537 A1
(43) Pub. Date: Oct. 18, 2012

(54) MOUNTS FOR CONTAINERS

(76) Inventors: Michael Sean Farrell, Terrace Park, OH (US); Chelsea Faith McLemore, Astoria, NY (US); Emma Lynn Sartini, Cincinnati, OH (US); Ashley Lynn Kuntz, Cincinnati, OH (US)

(21) Appl. No.: 13/439,149

(22) Filed: Apr. 4, 2012

Related U.S. Application Data
(60) Provisional application No. 61/474,850, filed on Apr. 13, 2011.

(51) Int. Cl. F16M 13/00

(52) U.S. Cl. 248/313

(57) ABSTRACT

In one form of the present disclosure, a mount for a container is provided. The container comprises a recessed bottom surface at least partially surrounded by a wall extending therefrom. The wall comprises a projection extending therefrom in a direction transverse to a plane of a side of the wall. The mount comprises a base and a tab extending from the base. The tab is configured to be positioned at least partially intermediate the projection and the recessed bottom surface to retain the mount to the container.

### CROSS REFERENCE TO RELATED APPLICATION

This application claims the benefit of U.S. Provisional Application No. 61/474,850 filed on Apr. 13, 2011, the entire disclosure of which is fully incorporated by reference herein.

### FIELD

The present disclosure generally relates to mounts for containers, containers, and dispensing assemblies.

### BACKGROUND

Disposable consumer products in the form of paper towels, toilet tissue, facial tissue, wipes, wet wipes, shop towels, and table napkins find great utility among users who value affordability, ease of use, and disposability. Such disposable consumer products are used in virtually every household, including in kitchens, bathrooms, dining rooms, and garages, for example. Wipes, such as adult wet wipes, baby wet wipes, and cleaning and scrubbing wipes, for example, are commonly sold in containers. These containers function to maintain the wipes “wet” or sufficiently saturated before use and generally have some type of seals or closures thereon. If the containers are left open to the environment for any significant period of time, the moisture within or on the wipes can evaporate, thereby leaving at least the exposed wipes dry or mostly dry, which is usually undesirable. Some consumers place current containers of wipes in bathrooms, such as on the back of a toilet, on a vanity, or in a bathroom cabinet, for example. When the wipes are used as sanitary tissues for users sitting on a toilet or for cleaning of the toilet, this placement of the wipes may be inconvenient or cumbersome. It would be desirable to provide mounts for containers, such as containers of wet wipes, other paper or nonwoven products, or other items, for example, and dispensing assemblies that would allow for more convenient dispensing and positioning of the containers within a bathroom setting, a kitchen setting, or other setting.

### SUMMARY

In one embodiment, the present disclosure is directed, in part, to a mount for a container. The container comprises a recessed bottom surface at least partially surrounded by a wall extending therefrom. The wall comprises a projection extending therefrom in a direction transverse to a plane of a side of the wall. The mount comprises a base and a tab extending from the base. The tab is configured to be positioned at least partially intermediate the projection and the recessed bottom surface to retain the mount to the container.

In one embodiment, the present disclosure is directed, in part, to a dispensing assembly comprising a container. The container comprises a recessed bottom surface at least partially surrounded by a wall extending therefrom. A projection extends from the wall. A recess is defined in the recessed bottom surface. The assembly comprises a mount comprising a base comprising an engagement member extending therefrom. The engagement member is configured to be at least partially engaged with the recess. The assembly comprises a tab extending outwardly from the base. The tab is configured to be positioned at least partially intermediate the projection and the recessed bottom surface to retain the mount to the container.

In one embodiment, the present disclosure is directed, in part, to a mount for a container. The container comprises a recessed bottom surface at least partially surrounded by a wall extending therefrom. The wall comprises a projection extending therefrom. The mount comprises a base comprising a fragrance packet and a tab extending from the base. The tab is configured to be positioned at least partially intermediate the projection and the recessed bottom surface to retain the mount to the container. The mount comprises a spacer engaged with one of the container and the base. The spacer comprises a portion having one of a recess and an aperture defined therein

In one embodiment, the present disclosure is directed, in part, to a container for wet wipes or other items. The container comprises a cavity defined in the container. The cavity is configured to receive the wet wipes or other items. The cavity comprises a top defining an opening and a bottom wall. The wet wipes or other items are is dispensable from the cavity through the opening. The cavity comprises an indent formed in the bottom wall. The indent extends into the cavity.

In one embodiment, the present disclosure is directed, in part, to a mount for a container. The mount comprises a base comprising one or more feet configured to engage a surface, a tab configured to engage a portion of the container, and a release portion configured to cause the one or more tabs to release from the container. The base also comprises a flange. The flange is configured to at least partially surround the container when the container is positioned on the mount. A receiving slot configured to receive a fragrance packet is defined in the base. The base comprises one or more ramped portions extending into the slot and configured to engage the fragrance packet.

### BRIEF DESCRIPTION OF THE DRAWINGS

The above-mentioned and other features and advantages of the present disclosure, and the manner of attaining them, will become more apparent and the disclosure itself will be better understood by reference to the following description of non-limiting embodiments of the disclosure taken in conjunction with the accompanying drawings, wherein:

FIG. 1 is a perspective view of a container mounted to a wall with a mount in accordance with one non-limiting embodiment;

FIG. 2A is an illustration of a wall extending from a recessed bottom surface of the container and having a recessed groove or aperture defined therein in accordance with one non-limiting embodiment;

FIG. 2B is an illustration of a wall extending from a recessed bottom surface of the container and having a plurality of recesses or apertures defined therein in accordance with one non-limiting embodiment;

FIG. 2C is an illustration of a wall extending from a recessed bottom surface of a container comprising a plurality of projections extending therefrom and having a plurality of recesses defined therein in accordance with one non-limiting embodiment;

FIG. 2D is a cross-sectional view of the wall of FIG. 2C taken about line 2D-2D of FIG. 2C in accordance with one non-limiting embodiment;

FIG. 3 is a perspective view of a container configured to be retained to a surface in accordance with one non-limiting embodiment;

FIG. 4 is a perspective view of a mount configured to retain the container of FIG. 3 to a surface in accordance with one non-limiting embodiment;

FIG. 5 is a view of the mount of FIG. 4 engaged with the container of FIG. 3 in accordance with one non-limiting embodiment;

FIG. 5A is a cross-sectional view of a portion of a base comprising an engagement member engaging a recess in a recessed bottom surface of a container in accordance with one non-limiting embodiment;

FIG. 5B is an illustration of a container of wet wipes or other items comprising an indent in the bottom wall thereof in accordance with one non-limiting embodiment;

FIG. 6 is a perspective view of the container of FIG. 3 in accordance with one non-limiting embodiment;

FIG. 7 is a perspective view of a mount for the container of FIG. 6 in accordance with one non-limiting embodiment;

FIG. 8 is a perspective view of the mount of FIG. 7 engaged with the container of FIG. 6 in accordance with one non-limiting embodiment;

FIG. 9 is a perspective view of the container of FIG. 3 engaged with a mount in accordance with one non-limiting embodiment;

FIG. 10 is a perspective view of the mount of FIG. 9 and a fragrance packet engaged with the mount in accordance with one non-limiting embodiment;

FIG. 11 is a top view of the container and mount of FIG. 9 retained to a wall in accordance with one non-limiting embodiment;

FIG. 12 is a perspective view of the container of FIG. 9 and the mount of FIG. 10 mounted to a wall in accordance with one non-limiting embodiment;

FIG. 13 is a bottom view of a container having slots defined in a bottom surface thereof in accordance with one non-limiting embodiment;

FIG. 14 is a cross-sectional view of the container of FIG. 13 taken about line 14-14 in accordance with one non-limiting embodiment;

FIG. 15 is a front view of a mount in accordance with one non-limiting embodiment;

FIG. 16 is a cross-sectional view of the mount of FIG. 15 taken about line 16-16 in accordance with one non-limiting embodiment;

FIG. 17 is a perspective view of a container engaged with a mount that is positioned on a surface in accordance with one non-limiting embodiment;

FIG. 18 is a top view of the container engaged with the mount of FIG. 17 in accordance with one non-limiting embodiment;

FIG. 19 is a side view of the container engaged with the mount of FIG. 17 in accordance with one non-limiting embodiment;

FIG. 20 is a perspective view of the mount of FIG. 17 in accordance with one non-limiting embodiment;

FIG. 21 is a top view of the mount of FIG. 20 in accordance with one non-limiting embodiment;

FIG. 22 is a cross-sectional view of the mount taken about line 22-22 of FIG. 21 in accordance with one non-limiting embodiment; and

FIG. 23 is a side view of the mount of FIG. 20 in accordance with one non-limiting embodiment.

### DETAILED DESCRIPTION

Various non-limiting embodiments of the present disclosure will now be described to provide an overall understanding of the principles of the structure, function, manufacture, and use of the containers, dispensing assemblies, and mounts for containers disclosed herein. One or more examples of these non-limiting embodiments are illustrated in the accompanying drawings. Those of ordinary skill in the art will understand that the containers, dispensing assemblies, and mounts for containers specifically described herein and illustrated in the accompanying drawings are non-limiting example embodiments and that the scope of the various non-limiting embodiments of the present disclosure are defined solely by the claims. The features illustrated or described in connection with one non-limiting embodiment may be combined with the features of other non-limiting embodiments. Such modifications and variations are intended to be included within the scope of the present disclosure.

In various embodiments, the present disclosure, in part, provides mounts for containers of one or more wet wipes or other items, containers of one or more wet wipes, dry wipes, or other items, and dispensing assemblies that can be used in bathroom setting, kitchen setting, garage setting, or in another setting. The containers of the present disclosure can comprise one or more rigid or flexible doors configured to seal a receiving cavity of the containers from an external environment to maintain any wet wipes or other items within the receiving cavity in a wet, substantially saturated state, dry, and/or uncontaminated state (i.e., protect from contamination or dirt). The containers can have rigid and/or flexible portions or can be entirely made of rigid or flexible materials. In various embodiments, the containers of the present disclosure can be reusable by refilling the receiving cavities with additional wet wipes or other items, or can be designed for a single use. The single use containers can be disposed of after use of all or most of the wet wipes or other items therein. The single use containers can be made of a light weight plastics, recycled fibers, paperboard, and/or films, for example.

The term “item” as used herein means one or more fibrous substrates, including nonwoven and woven fibrous substrates comprised of cellulosic fibers, synthetic fibers, other fibers, mixtures thereof, and/or other materials. The items can comprise paper towels, toilet tissue, wipes, such as cleaning, scrubbing, dry, and/or wet wipes, disposable hand towels, sanitary napkins, diapers, table napkins, cleaning products, and/or make-up removal products. If more than one fibrous substrate is provided, the items can be in stacks or rolls. Various items can be single-ply structures or multi-ply structures.

The containers of the present disclosure can also be configured to dispense lotions, soaps, liquids, antimicrobial materials, antibacterial materials, medicinal agents, and/or medications.

The term “wet wipes” as used herein means any fibrous substrate, whether woven or nonwoven, having a percent of moisture by weight in the range of about 10 percent to about 1,000 percent and, specifically reciting all 1 percents within that range. The wet wipes can be adult wet wipes, such as CHARMIN® FRESHMATES® manufactured by The Procter & Gamble Company, that can be used as sanitary tissues, baby or child wet wipes, such as PAMPERS® to wipes or PAMPERS® KANDOO® wipes, and/or other wet wipes, such as wet wipes for cleaning or scrubbing, for example. The wet wipes can be comprised of cellulosic fibers, synthetic fibers, mixtures thereof, and/or other materials or fibers. The wet wipes can be single-ply structures or multi-ply structures. In one embodiment, the wet wipes can be flushable down a toilet. In various embodiments, a composition or a component can be provided to or formed with the wet wipes during or after manufacturing to make the wipes moist or wet. Such compositions or components can be water, lotions, cleaning products, medicinal agents, antimicrobial agents, antibacterial agents, soaps, and/or mixtures thereof, for example.

In various embodiments, the wet wipes or other items can be provided within or placed within the receiving cavities of the containers in rolls, stacks, folded sheets, interfolded sheets, semi-interfolded sheets, perforated sheets, and/or unfolded sheets, for example. The folded sheets can be C-folded sheets, L-folded sheets, Z-folded sheets, or W-folded sheets. Any suitable number of wet wipes or other items can be provided within a receiving cavity of a container. When one wet wipe or other item is dispensed from a container, another wet wipe or other item can be moved into a partially dispensed position (e.g., interfolded, semi-interfolded, or perforated sheets of wet wipes or other items). One or more wet wipes or other items can be dispensed at a time using the dispenser assemblies and/or the containers of the present disclosure. In one embodiment, one hand or two hand dispensing can be accomplished using the dispensing assemblies and containers of the present disclosure. In one embodiment, a container can comprise a generally flat bottom surface or other surface. An adhesive, one component of a hook and loop fastener, and/or one or more suctions cups can be provided on the bottom surface or other surface for attaching the container to a vertical wall or other surface, for example. In other embodiments, an adhesive can be provided directly to a vertical wall or other surface to attach the bottom surface or other surface of the container to the vertical wall or other surface.

Although the present disclosure discusses wet wipe dispensing, it is within the scope of the present disclosure to dispense other items from the dispenser assemblies and/or the containers. In various embodiments, the receiving cavities of the containers can comprise fragrancing materials. In one embodiment, fragrancing materials, such as hot melt adhesives comprising perfumes, for example, may be positioned within the receiving cavities of the containers for diffusion into the wet wipes or other items positioned within the receiving cavities. Such hot melt adhesives are disclosed in U.S. Pat. No. 7,850,038, issued on Dec. 14, 2010. In various embodiments, fragrancing materials such as scented polymer beads or gels can also be used.

In various embodiments, although not illustrated, suitable toilet tissue bars can be attached to, formed with, or engaged with the containers, dispenser assemblies, mounts, and/or spacers of the present disclosure. Such toilet tissue bars can be configured to rotatably retain a roll of toilet tissue thereon. In one embodiment, a container, dispenser assembly, mount, or spacer can comprise a toilet tissue bar holder comprising a first projection and a second projection. A toilet tissue bar can be inserted between the first projection and the second projection, such that a roll of toilet tissue can be rotatably retained thereon.

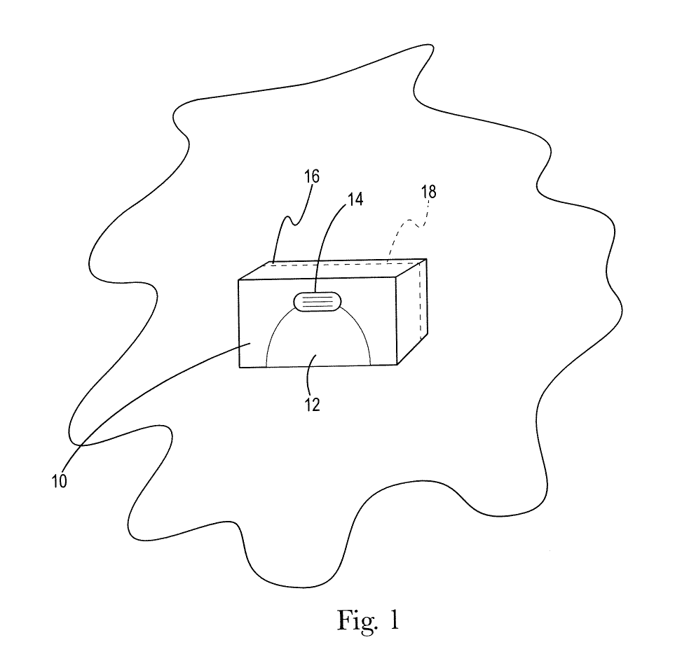

In one embodiment, a mount can be attachable to or engagable with a container comprising or configured to receive wet wipes or other items. The mount can be configured to be attached to or retained on a wall or other surface either before or after engagement with the container. The mount can be used to retain the container to a vertical surface, for example. In one embodiment, referring to FIG. 1, a container of wet wipes or other items can be retained to a wall 20 using a mount (not illustrated in FIG. 1). The container 10 can comprise a door 12 configured to move between an open position and a closed position. When the door 12 is in the open position, access to a receiving cavity defined within the container 10 can be provided and when the door 12 is in the closed position, access to the receiving cavity may not be provided. The door 12 can be released from the closed position by depressing a button 14, for example. In one embodiment, when the button 14 is depressed, the door 12 can spring open or automatically move into the open position through the use of a torsion spring, for example, or other biasing or spring-like member, acting upon a portion of the door 12, a portion of the container 10, and/or a pivot or hinge of the door 12. In various embodiments, a seal can be positioned on the door 12 or on any suitable portion of the container 10 to create an air-tight, or substantially air-tight, seal between the door 12 and a portion of the container 10 to maintain the wet wipes or other items, in a wet, dry, and/or uncontaminated state.

In various embodiments, the container 10 can comprise a recessed bottom surface (indicated by a dotted line in FIG. 1) and a wall 16 can extend from, or extend outwardly from, the recessed bottom surface to form a void 18 intermediate the recessed bottom surface and a portion of the wall 20 or other surface. In various embodiments, a mount (not illustrated in FIG. 1) can be positioned at least partially within the void 18 when the mount is retaining the container 10 to the wall 20 or other surface. In such an embodiment, the mount can be hidden from, or partially hidden from, a user when the container 10 is positioned on the wall 20 (see e.g., FIG. 1) or other surface.

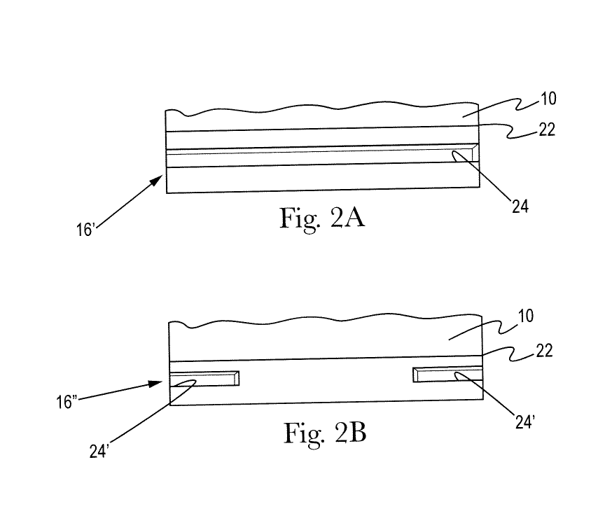

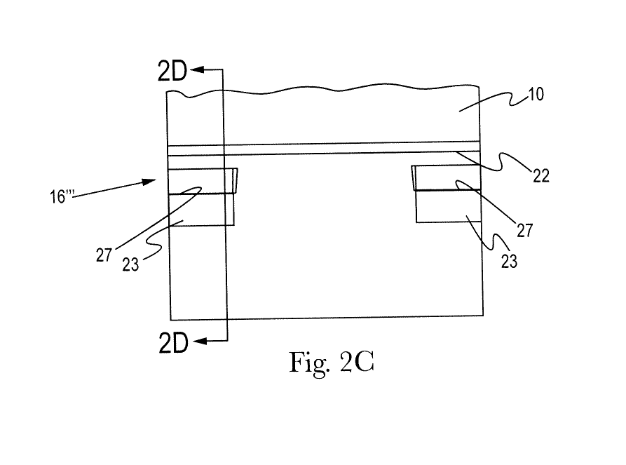

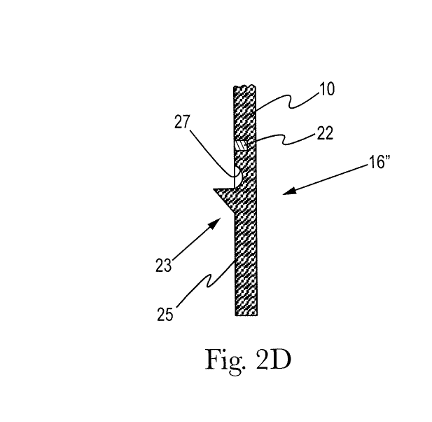

In one embodiment, referring to FIGS. 2A and 2B, example portions or sides of walls 16′ and 16″ extending from a recessed bottom surface 22 of the container 10 are illustrated. In FIG. 2A, a recessed groove or an aperture 24 (hereafter referred to as a “recessed groove”) is illustrated in the wall 16′. The recessed groove 24 can extend substantially about the length of the wall 16′. In various embodiments, the recessed groove 24 can be formed in the wall 16′. In such an embodiment, the outer surface of the wall 16′ can be flush with an outer side wall of the container 10 in an area on an opposite side of the wall 16′ as the recessed groove 24. In other various embodiments, the outer surface of the wall 16′ can extend outwardly from a plane of the outer side wall of the container 10 in an area on an opposite side of the wall 16′ as the recessed groove 24. The depth of any recessed grooves 24 formed in the wall 16′ can be sufficient to engage at least a portion of a tab of a mount and enable the mount to retain or releasably retain the container 10 thereto. In one embodiment, the mount can comprise a single tab configured to engage the recessed groove 24 in the wall 16′ to retain or releasably retain the mount to the container 10. In various other embodiments, any number of recessed grooves 24 can be provided in the wall 16′. As a result, any number of tabs can extend from the mount, wherein at least some of the tabs can engage the recessed grooves 24 in the wall 16′. In one embodiment, referring to FIG. 2B, one or more recesses or apertures 24′ (hereafter “recesses”) can be formed in the wall 16″ extending from the recessed bottom surface 22 of the container 10. In one embodiment, the recesses 24′ can be positioned at corners or rounded portions of the wall 16″ (although not illustrated). In various embodiments, the recesses 24′ can be positioned at all four corners of a wall or less than four corners of the wall.

In one embodiment, referring to FIGS. 2C and 2D, one or more projections 23 can extend from the wall 16′″ extending from the recessed bottom surface 22 of the container 10. The projections 23 can be positioned proximate to one or more corners in the wall 16′″ or at any other suitable locations on the wall 16′″. The projections 23 can extend in a direction transverse, perpendicular, or generally perpendicular to a plane of a side 25 of the wall 16′″. The projections 23 can have any suitable shape or dimensions to engage at least portion of tabs of a mount. In various embodiments, recesses 27 can be formed at least partially or fully intermediate the projections 23 and the recessed bottom surface 22. In one embodiment, at least a portion of a tab of a mount can be engaged with a portion of each recess 27 and/or the projections 23 to retain the mount to the container 10. In various embodiments, each recess 27 can extend from the projection 23 to the recessed bottom surface 22. In one embodiment, a generally flat portion of the side 25 of the wall 16′″ can be positioned intermediate a projection 23 and the recessed bottom surface 22 and a recess in the side 25 may not be provided.

In various embodiments, a mount can attach directly to the recessed bottom surface 22 or to one or more side walls of the container 10. In one embodiment, the recessed bottom surface 22 can have a clip or member extending therefrom and the mount can have a corresponding attachment structure thereon, such as a groove or a slot, for example, configured to engage the clip or member. In other various embodiments, the mount can be adhered to the wall 16 and/or to the recessed bottom surface 22 using a suitable adhesive or adhesive strip. The mount can also be removably attached to a wall or other surface using hook and loop fasteners, hook and hook fasteners, or other releasable fasteners, for example. In one embodiment, outer side walls of a container can have recesses or indentations defined therein and a mount can comprise a base with two or more projections extending therefrom. The projections can each comprise lips or other members configured to engage the recesses or indentations defined in the side walls of the container to retain the mount to the container, for example. The projections can be biased toward each other such that the container can be releasably retained to the mount. In other embodiments, the mounts of the present disclosure can be engaged with or attached to the recessed bottom surface 22 of the container 10, or other portions of the container 10 generally, using any suitable methods and apparatuses known to those of skill in the art.

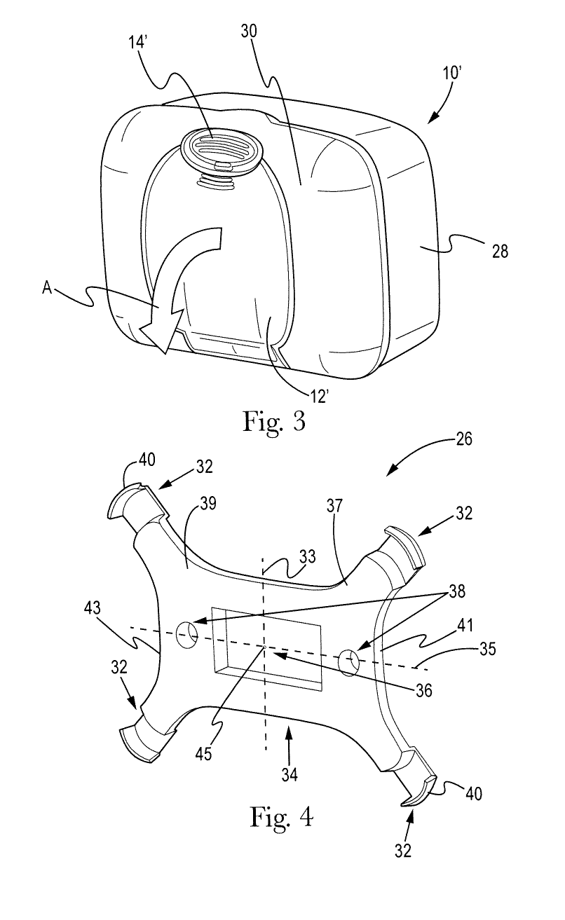

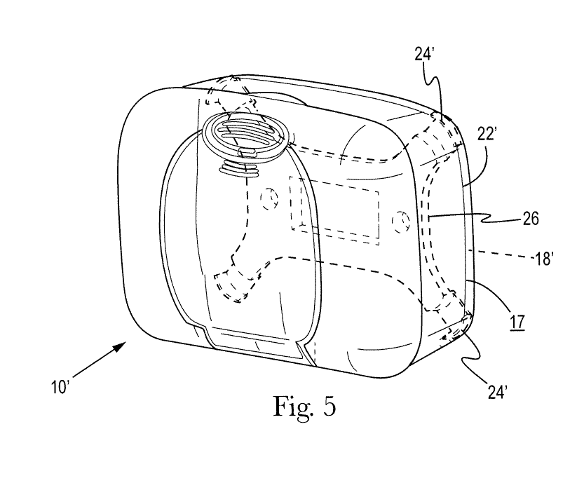

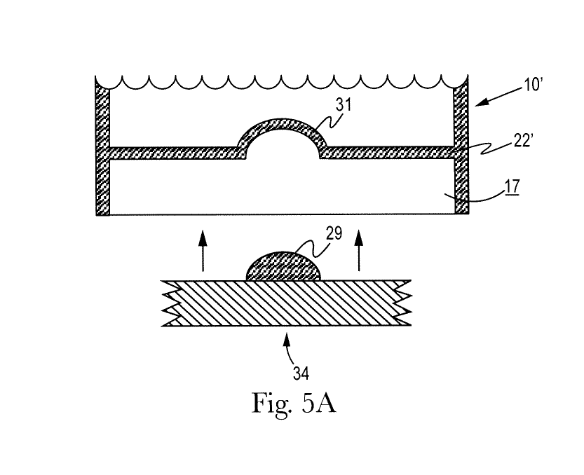

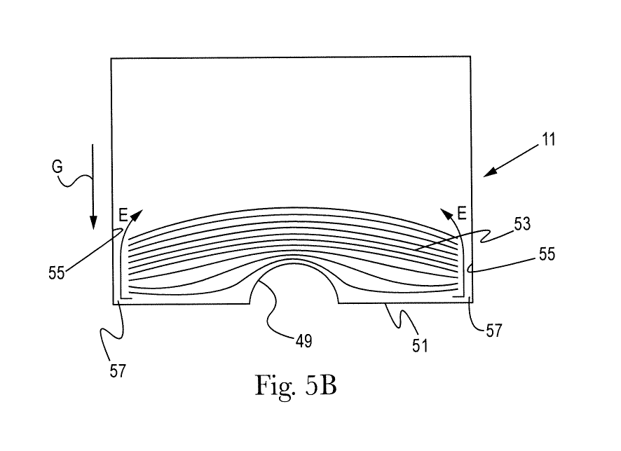

In one embodiment, referring to FIGS. 3-5, a container 10′ and a mount 26 are illustrated. In FIG. 5, the mount 26 is illustrated engaged with the container 10′. The container 10′ can be mounted to a wall or other surface, such that a door 12′ can open by pivotably moving downwardly (in the direction of arrow “A”) and can close by pivotably moving upwardly. In other various embodiments, the door 12′ can open by pivotably moving upwardly and can close by pivotably moving downwardly. Of course, the container 10′ can also be mounted to a wall or other vertical surface such that the door 12′ opens with right to left pivotal movement or with left to right pivotal movement. In still other embodiments, the door 12′ can open and/or close in any suitable direction depending on the orientation of the mount 26 on the wall or other surface.

In one embodiment, the container 10′ can comprise one or more side walls 28 and a lid 30. The container 10′ can have any suitable shape for various applications. The lid 30 can comprise the door 12′ and a button 14′, similar to that described above with respect to the container 10. The lid 30 can open independent of the door 12′ to allow refilling of the receiving cavity defined by the container 10′. In various embodiments, the lid 30 can be pivotably engaged with a side wall 28 of the container 10′ or can merely be positioned on the container 10′ and removable therefrom. In one embodiment, the door 12′ may not be present on the container 10′ and the lid 30 can be opened to remove one or more wet wipes or other items from the container 10′ and to refill the container 10′ with wet wipes or other items.

In various embodiments, the container 10′ can comprise a recessed bottom surface 22′ and a wall 17 extending therefrom. The wall 17 can extend from the recessed bottom surface 22′ in a direction generally away from the lid 30 when the lid 30 is in the closed position. The wall 17 can extend from about 0.2 inches to about 1.25 inches from the recessed bottom surface 22′, and specifically reciting all 0.01 inch increments with that range. A void 18′ formed between a surface on which the container 10′ is mounted and the recessed bottom surface 22′ can be deep enough to receive a portion of the mount 26, or the entire mount 26, therein. In one embodiment, a portion of the mount 26 can extend from the void 18′ when the mount 26 is attached to the container 10′. The portion of the mount 26 that extends from the void 18′ can be used to attach the mount 26 to a wall or other surface, for example. In various embodiments, the wall 17 can surround, or at least partially surround, the recessed bottom surface 22′. The wall 17 can be continuous or discontinuous. In one embodiment, the wall 17 can have recesses and/or apertures defined therein to allow air to flow from an environment of the container 10′, through the void 18′, and back to the environment for fragrance purposes, for example. In such an embodiment, the void 18′ can have a perfume or fragrance therein. The perfume or fragrance can be provided by a hot melt adhesive, scented polymer beads, scented gels, and/or a fragrance packet, for example, as described in greater detail below.

When the container 10′ is positioned on a surface (i.e., bottom-most portion of the wall 17 contacting or positioned proximate to the surface), the void 18′ can be formed intermediate the surface, such as a wall, for example, and the recessed bottom surface 22′. One or more projections 23 (see e.g., FIGS. 2C and 2D) can extend from the wall 17. In one embodiment, the projections 23 can extend from the wall 17 in a transverse direction or a generally perpendicular direction relative to the side 25 of the wall 17. In one embodiment, the projections 23 can be formed proximate to or at one or more corners of the wall 17. In various embodiments, the wall 17 can have four corners, or rounded areas, and a projection 23 can be defined at or proximate to each corner or rounded area. The projections 23 can each be configured to engage a tab of the mount 26. The wall 17 can define one or more of the apertures or recesses 24′ (hereafter “recesses”) therein. The recesses 24′ can be positioned at least partially intermediate the projections 23 and the recessed bottom surface 22′. The recesses 24′ can have any suitable shape or dimensions, or depth. The apertures or recesses 24′ can be configured to at least partially receive tabs 32 extending from, formed with, or attached to the mount 26. Any number of recesses 24′ can be formed in the wall 17. In various embodiments, the number of recesses 24′ can correspond to the number of tabs 32 on the mount 26. In one embodiment, a wall can have both recesses and apertures therein or only one of recesses and apertures therein. The tabs 32 on the mount 26 can be configured to engage both of, or either of, the recesses and/or apertures 24′ in the wall 17. In various embodiments, one or more apertures 24′, alternatively, two recesses 24′, alternatively, three recesses 24′, and alternatively, four recesses 24′ can be defined in the wall 17. In other various embodiments, any suitable number of recesses and/or apertures 24′ can be defined in the wall 17. In one embodiment, the number of projections 23 can be the same as the number of recesses 24′. In still other embodiments, only the projections 23 may be provided on the wall 17 or, alternatively, only the recesses or apertures 24′ can be provided in the wall 17.

In one embodiment, still referring to FIGS. 3-5, the mount 26 can comprise a base 34 and one or more tabs 32 extending from the base 34. The base 34 can comprise a raised portion 36 that extends outwardly from or that is raised from a normal plane of the base 34. In one embodiment, the raised portion 36 can extend outwardly on both sides of the base 34 (i.e., the raised portion 36 is thicker than the base 34). When the mount 26 is engaged with the container 10′, the raised portion 36 can extend from the void 18′ or can extend so that it is flush with, or substantially flush with, the bottom-most surfaces of the wall 17. The raised portion 36 or other areas of the base 34 can comprise an adhesive or one or more adhesive strips on a side of the raised portion 36 facing away from the recessed bottom surface 22′. The adhesive or adhesive strips can be used to attach the mount 26 to a surface or a wall. A removable film or sheet can be positioned over the adhesive or adhesive strips so that the adhesive does not stick or bind to surfaces or objects until the appropriate mounting time. The adhesive strips can also be attachable to the raised portion 36 or other areas of the base 34. The raised portion 36 or other portions of the base 34 can comprise fastener apertures 38 therein through which fasteners, such as screws, for example, can be inserted to attach the base 34 to a surface or a wall. In one embodiment, the fastener apertures 38 can be covered by removable knock-outs. In other embodiments, the raised portion 36, or other portions, of the base 34 can comprise one or more suction cups or one component of hook and loop or hook and hook fasteners (with the other component being provided on a wall or other surface) configured to attach the mount 26 to a wall or other surface. The hook and loop or hook and hook fasteners can have an adhesive or one or more adhesive strips on a back side thereof such that they can be attached to the base 34 or to a wall or other surface.

In various embodiments, the tabs 32 can extend outwardly from a plane of the base 34 and/or outwardly in a direction transverse, perpendicular, or generally perpendicular to a plane of the base 34. In other embodiments, one or more tabs can extend outwardly about a perimeter of the base 34 or about a majority of a perimeter of the base 34, for example. In such embodiments, the tabs can be continuous or discontinuous. In one embodiment, the tabs 32 can comprise a lip 40 configured to engage the recesses 24′ and/or the projections 23 in the wall 17 of the container 10′. The tabs 32 can be normally-biased away from the base 34 such that they can engage the projections 23 and/or the recesses 24′ when the mount 26 is engaged with the container 10′. In one embodiment, the tabs 32 can be press-fit or snap-fit with the projections 23 and/or the recesses and/or apertures 24′ in the wall 17. In various embodiments, four tabs 32 can extend from the base 34, thereby creating an “X like” mount structure. In other various embodiments, mounts that can be used with the container 10′ can comprise any other suitable shape that is configured to engage the projections 23 and/or the recesses 24′ in the wall 17, engage the recessed bottom surface 22, and/or engage the container 10′ or a portion thereof.

In various embodiments, still referring to FIGS. 3-5, the mount 26 can be engaged with the wall 17 of the container 10′, within, or at least partially within, the void 18′, prior to mounting the base 34, or other portion of the mount 26, to a surface (e.g., an adhesive or one or more adhesive strips can be present on or attachable to the base 34) or after mounting the base 34 to a surface. In one embodiment, the mount 26 or the base 34 can be rotated once within, or partially within, the void 18′ to engage the tabs 32 with the projections 23 (see e.g., FIGS. 2C and 2D) and/or the recesses or apertures 24′. In other embodiments, the base 34 can be pushed directly toward the recessed bottom surface 22′ to engage the tabs 32 with the projections 23 and/or the recesses 24′. The tabs 32 can be disengaged with the projections 23 and/or removed from the recesses 24′ for replacement of the container 10′ or refilling of the container 10′. Removal can be accomplished by pushing the tabs 32 out of the apertures 24′ and into the void 18′ and then removing the container 10′ from the mount 26. In other various embodiments, removal can be accomplished by pulling the container 10′ in a direction away from the wall or other surface to which the base 26 is mounted. Removal can also be accomplished by rotating the base 34 to disengage the tabs 32 from the projections 23 and/or the recesses 24′. Such rotation can be in an opposite direction or in the same direction as the rotational movement used to engage the tabs 32 with the projections 23 and/or the recesses 24′. In such an embodiment, the tabs 32 can have a ramped or angled portion (not illustrated) thereon that can allow for rotational removal and insertion of the tabs 32 from the projections 23 and/or the recesses.

In various embodiments, the base 34 can have a first axis 33 extending in a vertical or generally vertical direction through a center point 45 of the base 34 and a second axis 35 extending in a horizontal or generally horizontal direction through the center point 45 of the base 34. The first axis 33 can extend in a perpendicular, or generally perpendicular, direction relative to the second axis 35. A first portion 37 of the base 34 on a first side of the first axis 33 can be symmetrical, or substantially symmetrical, to a second portion 39 of the base 34 on a second side of the first axis 33. A third portion 41 of the base 34 on a first side of the second axis 35 can be symmetrical, or substantially symmetrical, to a third portion 43 of the base 34 on a second side of the second axis 35. Stated another way, the base 34 can be symmetrical about the first axis 33 and the second axis 35. A user can attach the base 34 to a wall or other surface such that the first axis 33 is generally vertical or horizontal. If the first axis 33 is vertical, a user can position the container 10′ on the base 34, such that the door 12′ of the container 10′ can open in the direction of arrow A of FIG. 3 (e.g., downwardly) or opposite to the direction of arrow A of FIG. 3. If the first axis 33 is horizontal or generally horizontal, a user can position the container 10′ on the base 34, such that the door 12′ of the container 10′ can open from left to right or from right to left. As a result, the base 34 of the present disclosure, once mounted to a wall, allows a user to choose one of two potential door opening directions to suit the user's needs or preferences.

In one embodiment, referring to FIGS. 3-5A, the center point 45 of the base 34, or other portion of the base 34 or mount 26, can comprise an engagement member 29 extending therefrom. The engagement member 29 can extend from a surface of the base 34 or mount 26 at least about 0.2 inches, alternatively, about 0.1 inches to about 1.5 inches, alternatively, about 0.2 inches to about 1 inch, and specifically reciting all 0.1 inch increments within those ranges. The engagement member 29 can have any suitable shape, such as a conical shape, a linear shape, a ridge-like shape, a semi-circular shape, a dome-like shape, a square shape, a rectangular shape, a triangular shape, an ovate shape, and an arcuate shape, for example, and any suitable dimension. The engagement member 29 can be hollow or solid. The engagement member 29 can be configured to engage a recess or indent 31 in the recessed bottom surface 22′ of the container 10′ such that the container 10′ can be easily aligned with the mount 26′ during engagement. The recess or indent 31 can be designed in dimension and/or shape to receive, or at least partially receive, the engagement member 29. In various embodiments, the recess or indent 31 can extend into the container 10′, relative to the cavity-facing side of the recessed bottom surface 22′, at least about 0.2 inches, alternatively, about 0.1 inches to about 1.5 inches, alternatively, about 0.2 inches to about 1 inch, and specifically reciting all 0.1 inch increments within those ranges. In one embodiment, the engagement member 29 extending from the base 34 and the recess or indent 31 in the container 10′ can essentially be configured for lock and key engagement of the base 34 and the recess 31 in the container 10′. If the engagement member 29 is provided about the center point 45 of the base 34 and the recess or indent 31 is defined in a center portion of a recessed bottom surface 22′ of the container 10′, the engagement of the mount 26′ with the container 10′ can essentially be self-aligning. Stated another way, by providing the engagement member 29 on the mount 26′ and the recess or indent 31 in the recessed bottom surface 22′, engagement between the mount 26′ and the recessed bottom surface 22′ can be easy and intuitive for a consumer. In one embodiment, more than one engagement member can be provided on the mount 26′ and more than one recess or indent can be provided on the recessed bottom surface 22′ to provide additional guidance during engagement of the mount 26′ with the recessed bottom surface 22′. In still other various embodiments, the mount 26′ can define the recess or indent and the recessed bottom surface 22′ can comprise the engagement member. In one embodiment, the engagement member 29 can prevent, or at least inhibit, the use of containers that do not comprise the recess or indent 31 with the mounts comprising the engagement member 29.

In one embodiment, still referring to FIGS. 3-5A, the present disclosure provides the container 10′ for a wet wipe or other item. The container 10′ has a cavity therein for receiving one or more wet wipes or other items. The container 10′ can comprise a top (e.g., lid 30) defining an opening therethough through which one or more of the wet wipes or other items can be dispensed. The container 10′ can also comprise a bottom wall (e.g., recessed bottom surface 22′) having an indent 31 formed therein. The indent 31 can extend into the cavity and/or towards the top. In one embodiment, the indent can form a conical shape, a semi-circular shape, a dome shape, an arcuate shape, a linear shape, a square shape, a rectangular shape, a triangular shape, an ovate shape, and/or a ridge-like shape, for example. In one embodiment, the indent can form a pillar-like structure extending into the cavity from the bottom wall. Any number of indents 31 can be provided in the bottom wall of the container 10′. In various embodiments, the indent 31 can be positioned at any suitable position on the bottom wall, such as about the midpoint of the bottom wall, for example. In one embodiment, the recess in the recessed bottom surface 22′ formed by the indent 31 can be used to engage at least a portion of the engagement member 29 extending from, attached to, or formed with the base 34.

In various embodiments, referring to FIG. 5B, an indent 49 in a bottom wall 51 of a container 11 can be used to maintain moisture throughout an entire stack of wet wipes 53 or other items positioned within the cavity. Due to gravity, moisture within a stack of wet wipes 53 within the cavity can migrate downwards, in the direction of arrow G, leaving the top portion of the wet wipes in the stack less wet or moist and the bottom portion of the wet wipes in the stack more wet or moist. While not intending to be bound by any theory, it is believed that by providing the indent 49 extending from the bottom wall 51 of the container 11 into the cavity having the wet wipes therein, moisture can be better diffused throughout the entire stack of wet wipes, as compared to a conventional wet wipe container having a generally flat bottom wall. As the moisture migrates downwardly, it can flow towards side walls 55 of the container 11 owing to the indent 49 being positioned in a central location in the bottom wall 51. Stated another way, the indent 49 can raise a central portion of the stack of wet wipes 53 relative to other portions of the stack of wet wipes 53 to cause the moisture to flow outwardly from the central portion. In one embodiment, the indent 49 can form a ridge extending about a central portion of the bottom wall 51. The ridge can cause the wet wipes to have a peak extending in a direction generally perpendicular or parallel to a longitudinal axis of the wet wipes. This can cause the moisture migrating downward to flow toward the side walls 55 of the container 11. A gap 57 can be formed within the cavity between the side walls 55 of the container 11 and the wet wipes. Moisture can accumulate in the gap 57 owing to the indent 49. Once the moisture accumulates in the gap 57, it can evaporate and diffuse back to the top portion of the stack of wet wipes 53 in the direction of arrow E, thereby keeping the top portion substantially wet. Without the indent 49, moisture may be trapped under the bottom portion of the stack of wet wipes 53 and may not be able to evaporate and diffuse back to the top portion of the stack of wet wipes.

In one embodiment, the container 11 can comprise a door (not illustrated) moveable between a first, open position and a second, closed position. The door can be configured to cover the opening in the top of the container 11 when in the second, closed position and configured to allow access to the opening when the door is in the first, open position. The door and/or an area surrounding the opening can comprise a seal or a sealing member configured to prevent, or at least inhibit, air from an environment of the container 11 from entering the cavity and drying out the wet wipes. The seal or sealing member can also be configured to prevent, or at least inhibit, air from the cavity, with moisture therein, from exiting the cavity, thereby maintaining the wet wipes in the saturated state. Other sealing members can be provided that do not actually have a sealing function, but that signal sealing to a consumer or provide other aesthetic benefits. The door of the container 11 can be similar to the door 12′ of FIG. 3 described above.

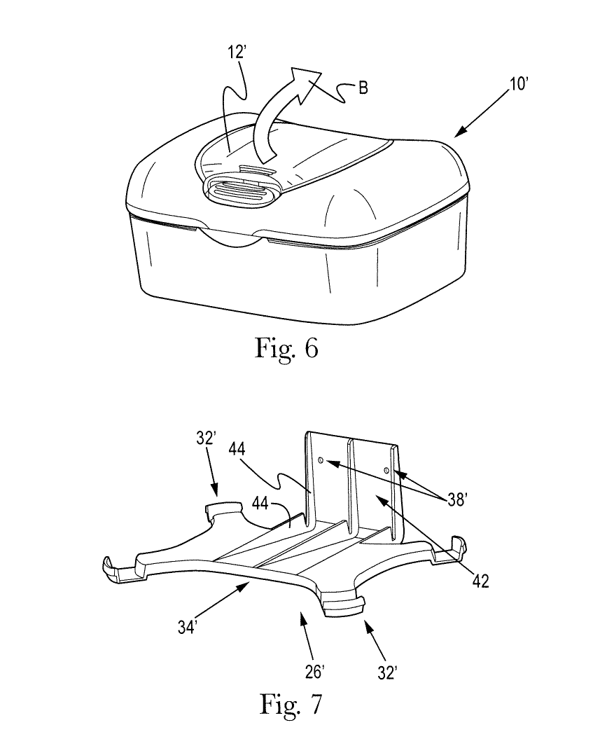

In one embodiment, referring to FIGS. 6-8, the container 10′ is illustrated being used with a mount 26′. The mount 26′ can be similar to the mount 26, but can also comprise a bracket 42 extending from a base 34′ in a direction transverse, perpendicular, or generally perpendicular to a normal plane of the base 34′. The bracket 42 can be used to attach the mount 26′ to a wall or other surface. As a result, the bracket 42 can comprise fastener apertures 38′, removable knock-outs, one or more adhesives or adhesive strips, and/or suction cups for attaching the mount 26′ to a wall or other surface. Of course, any other suitable type of fasteners or fastening devices, such as hook and loop fasteners, for example, can also be used to attach the bracket 42 to a wall or other surface. In one embodiment, the base 34′ may not comprise a raised portion, like the raised portion 36, since the bracket 42 can be used to attach the mount 26′ to a wall or other surface. The bracket 42 and/or the base 34′ can comprise one or more ribs 44 extending outwardly therefrom. The ribs 44 on the base 34′ can engage the recessed bottom surface 22′ of the container 10′ and the ribs 44 on the bracket 42 can engage a side wall of the container 10′. The ribs 44 on the base 34′ and the bracket 42 can function to provide the mount 26′ with structural integrity and increased stiffness. Depending on the material used to form the mount 26′, more or thicker material may be required to achieve suitable structural integrity and stiffness of the mount 26′ if the ribs 44 are not provided. In various embodiments, the ribs 44 can also comprise arcuate portions or other suitably shaped portions, for example.

By providing the bracket 42, or other brackets, extending from the base 34′, the container 10′ can be mounted on a wall or other vertical surface in a generally horizontal manner, where the base 34′ essentially acts like a shelf. In its most simple form, the base 34′ may not comprise tabs 32′ or the ribs 44 and may simply comprise a surface that can function as a generally horizontal shelf for supporting the container 10′. In other various embodiments, the base 34′ can function as a generally horizontal shelf and the container 10′ can be attached to the shelf, using the tabs 32′, the projections 23, and/or the recesses 24′ in the wall 17, in a similar manner as that discussed above. In such an embodiment, the door 12′ of the container 10′ can open toward or away from the wall or other vertical surface in the direction indicated by arrow “B.” In other embodiments, the door 12′ can be opened in other directions relative to the wall or other surface. In one embodiment, the base 34′ can have its longest dimension extending in a direction away from the bracket 42, such that the longest dimension of the container 10′ extends in a direction away from the bracket 42, when the container 10′ is positioned on the base 34′. In such an embodiment, the door 12′ can open in a direction from left to right or from right to left relative to a wall or other surface.

In one embodiment, although not illustrated, the bracket 42 can comprise or can be formed with a hook portion or hanger configured to engage an existing toilet tissue bar or toilet tissue holder, such that the mount 26′ and the container 10′ can be retained to the existing toilet tissue bar or toilet tissue holder. In other embodiments, the hook portion or hanger can be configured to engage an existing paper towel bar or paper towel holder, such that the mount 26′ and the container 10′ can be retained to the existing paper towel bar or paper towel holder. In still other embodiments, the bracket 42 can comprise or can be formed with a toilet tissue bar or paper towel bar configured to be engaged with a typical two post toilet tissue or paper towel holder. In such embodiments, the mount 26′ and the container 10′ can be retained to an existing toilet tissue or paper towel holder. If the bracket 42 comprises a hook portion or hanger, it can also be retained to a towel rack, a door, a toilet, or other suitable member from which the mount 26″ can hang or can be attached. In the embodiments discussed in this paragraph, a toilet tissue bar or paper towel bar can be attached to or formed with the containers or the mounts, such that a roll of toilet tissue or paper towels can be rotatably retained to the containers or the mounts. This concept can also apply to other embodiments discussed herein.

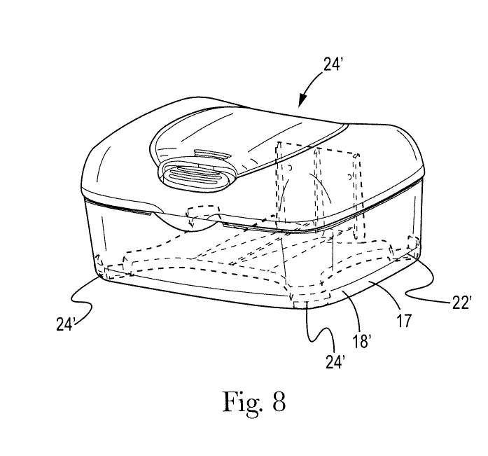

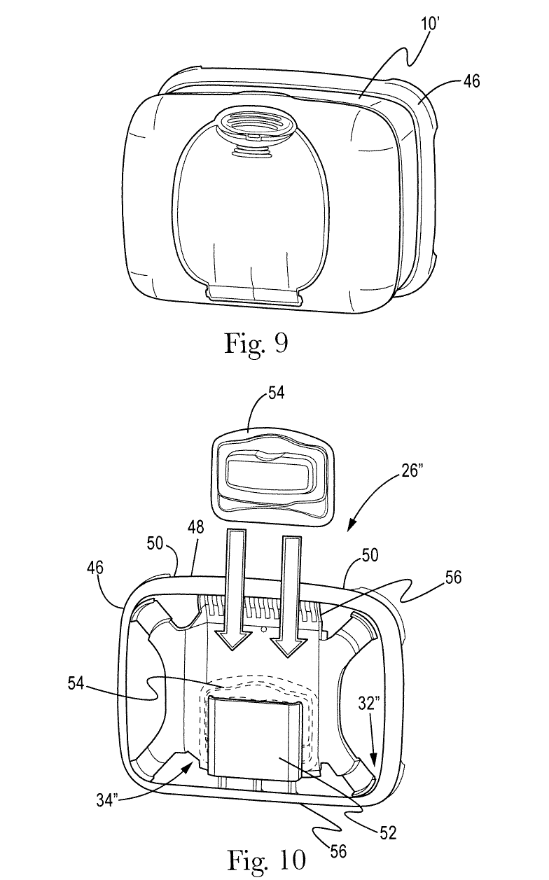

In one embodiment, referring to FIGS. 9-12, a mount 26″ is providing for attaching the container 10′ to a wall or other surface, such as a vertical surface, for example. The mount 26″ can comprise similar components as the mount 26 described above. The mount 26″ can also comprise a spacer 46 configured to allow air to flow through or past the void 18′ (see e.g., FIG. 8) and provide fragrance or perfume to an environment surrounding the container 10′. The spacer 46 can be engaged with, formed with, or attached to a base 34″. In other embodiments, the spacer 46 can be engaged with, formed with, or attached to the portions of the wall 17 (see e.g., FIG. 8) of the container 10′. In one embodiment, the spacer 46 can be engaged with the projections 23 and/or the recesses 24′ in the wall 17. In such an embodiment, the spacer 46 can comprise tabs, like tabs 32 described above, for engagement with the projections 23 and/or the recesses in the wall 17. The spacer 46 can be abutted with or positioned proximate to a surface or a wall when the container 10′ is mounted thereon or attached thereto. The spacer 46 can comprise a bottom wall 48 having one or more recesses 50 defined therein. In other various embodiments, although not illustrated, the spacer 46 can define one or more apertures therethrough. In one embodiment, a first recess 50 or aperture can be provided on a first side or portion of the spacer 46 and a second recess 50 or aperture can be provided in a second side or portion of the spacer 46. The purpose of the recesses 50 and/or the apertures is to allow air to flow through or over the void 18′ to provide perfumed air or a fragrance to the environment surrounding the container 10′. The scent can be provided by a fragrance packet, scented polymer beads, scented gels, and/or a hot melt adhesive comprising a perfume, for example, as described in greater detail below.

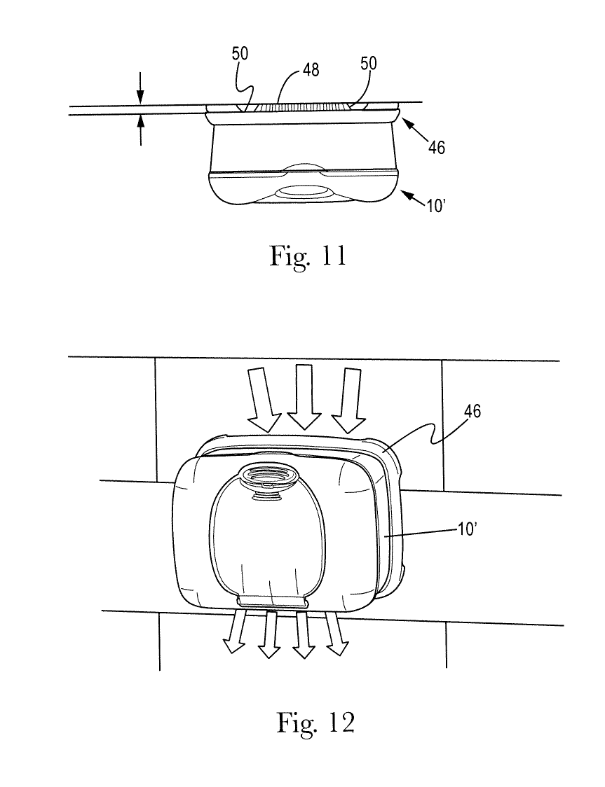

In one embodiment, the mount 26″ or the base 34″ can comprise or be attached to a sleeve 52 configured to receive a fragrance packet 54, such as a fragrance packet of FEBREZE® manufactured by The Procter and Gamble Company, for example. The sleeve 52 can extend over a portion of the base 34″ and can form a fragrance packet-receiving slot between itself and the base 34″. The fragrance packet 54 can be retained to the base 34″ by the sleeve 52 and/or retained within the void 18′ by the sleeve 52. In other various embodiments, the sleeve 52 may not be required and the fragrance packet 54 can be attached to, engaged with, adhered to, and/or formed with the base 34″, the spacer 46, the wall 17, and/or the recessed bottom surface 22′, for example. In one embodiment, a fragrance packet-receiving space can be defined in the base 34″. The fragrance packet 54 can be at least partially positioned within the fragrance packet-receiving space. In various embodiments, a hot melt adhesive comprising perfume can be positioned somewhere within the void 18′ on any suitable surface or component. This hot melt adhesive can take the place of the fragrance packet 54 or can be used on or in the fragrance packet 54. In any event, the fragrance packet 54 or the hot melt adhesive can diffuse a fragrance, such as a perfume, for example, to air within the void 18′. In other embodiments, scented polymer beads and/or scented gels can take the place of the fragrance packet 54 or can be used on or in the fragrance packet 54. When air flows through the recesses 50 and/or apertures in the spacer 46, the fragrance can be provided or flowed into the environment surrounding the container 10′. FIGS. 11 and 12 illustrate how air can flow through the recesses 50 or apertures in the spacer 46 to diffuse the fragrance into the environment surrounding the container 10′.

In one embodiment, the spacer 46 can be attached to, engaged with, or formed with the base 34″ using any suitable members, such as one or more strips 56, for example. In various embodiments, the spacer 46 can extend a first distance from the recessed bottom surface 22′ of the container 10′ and a raised portion (e.g., 36) of a base (e.g., 34) can extend a second distance. The second distance can be less than or greater than the first distance. In embodiments where the spacer 46 is attached to or formed with the wall 17 of the container 10′, the strips 56 may not be required. In various embodiments, the sleeve 52 can be attached to or formed with the strips 56. In an embodiment where the spacer 46 is formed with the container 10′ and attached to the base 34″, the tabs 32″ on the base 34″ may not be required for engagement of the mount to the container 10′. In one embodiment, a spacer (not illustrated) can comprise tabs configured to engage the projections 23 and/or the recesses 24′ in the wall 17. The spacer 46 can also comprise an adhesive or other mounting structure (e.g., fastener apertures, hook and loop) on a surface thereof that would face the wall or other surface when mounted on the wall or other surface. In such an embodiment, it may be possible to eliminate the base 34″ all together and just use the spacer 46 to attach the container 10′ to a wall or other surface.

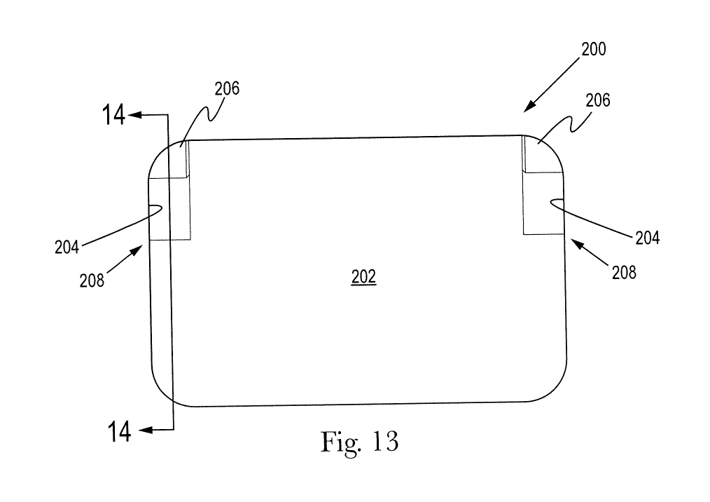

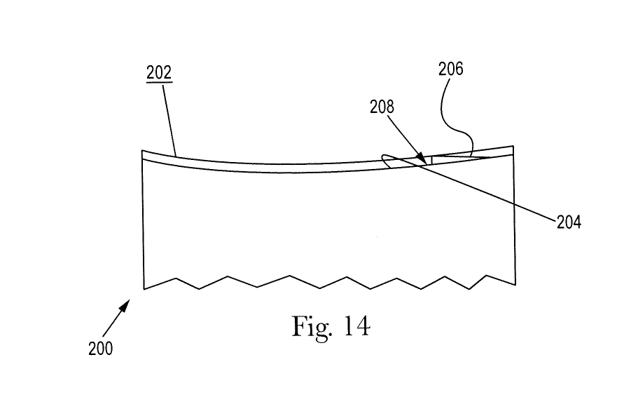

FIG. 13 is a bottom view of a container of items. FIG. 14 is a cross-sectional view of the container of FIG. 13 taken about line 14-14. In one embodiment, referring to FIGS. 13 and 14, a container 200 of items, such as wet wipes, for example, can have a bottom surface 202 that defines recesses 204 therein. A tab 206 can extend over a portion of each of the recesses 204 to essentially form receiving slots 208 in the bottom surface 202 of the container 200. In various embodiments, the recesses 204 can have an arcuate or ramped bottom surface. The container 200 can be a container of COTTONELLE FRESH® wipes sold by Kimberly-Clark Corporation, such as the container having the number 07/2008 BI619002X 0019 printed on the bottom surface thereof, for example. Because some consumers still do purchase COTTONELLE FRESH® wipes, a functional and easy to use system of attaching these containers to bathroom walls, kitchen walls, and/or other horizontal or vertical surfaces is important, and is described herein as one embodiment of the present disclosure.

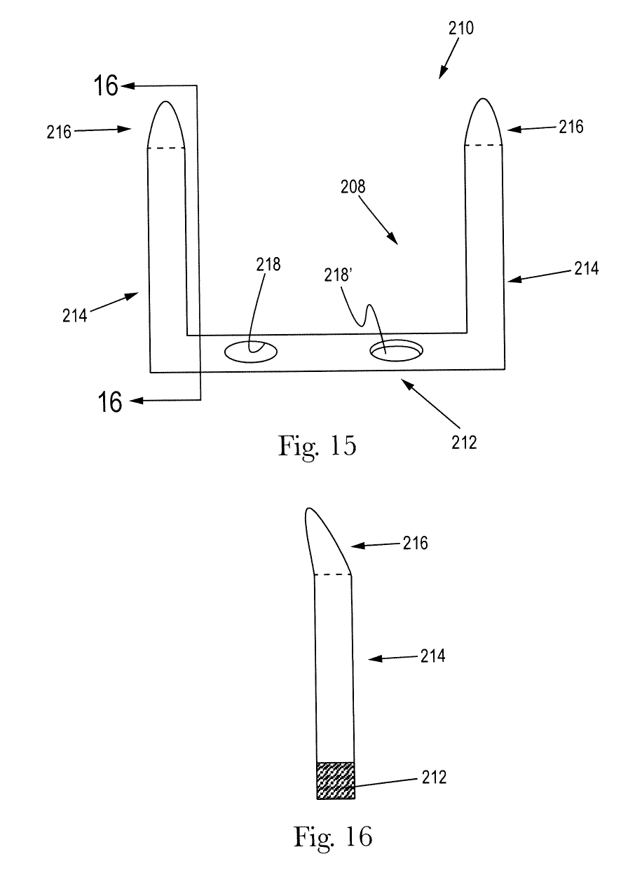

FIG. 15 is a front view of a mount. FIG. 16 is a cross-sectional view of the mount of FIG. 15 taken about line 16-16. In various embodiments, referring to FIGS. 15 and 16, a mount 210 can comprise a base 212 and projections 214 extending from the base 212. The projections 214 can extend in a perpendicular or transverse direction relative to a longitudinal axis of the base 212. The projections 214 can each comprise engagement portions 216 extending therefrom. In one embodiment, a longitudinal axis of each of the engagement portions 216 can be transverse to a longitudinal axis of the projections 214, such that the engagement portions 216 are offset from the projections 214. The mount 210 can be used to attach the container 200 to a wall or other surface. The base 212 of the mount 210, for example, can comprise fastener apertures 218 or knockouts 218′ for attachment of the mount 210 to a wall or other surface using suitable fasteners. In other embodiments, the base 212 can comprise an adhesive or one or more adhesive strips to mount the base 212 to a wall or other surface. In one embodiment, the base 212 can be attached to the wall or other surface using hook and loop or hook and hook fastening system, as understood by those of skill in the art.

In one embodiment, a user can attach the mount 210 to a wall or other surface with the projections 214 facing upwardly in the generally vertical direction or other suitable direction. By providing engagement portions 216 that extend from or that are offset from the projections 214, the projections 214 and the base 212 can be mounted generally flush with the wall or other surface and the engagement portions 216 can extend in a direction away from a plane of the wall or other surface. By providing such a feature, the engagement portions 216 can essentially act like hangers for the container 200. The container 200 can then be attached to the mount 210, by engaging at least a portion of the engagement portions 216 with at least a portion of the slots 208 formed in the bottom surface 202 of the container 200. In such a fashion, the container 200 can be hung on or positioned on the mount 210 and thereby attached to a wall or other surface. In various embodiments, containers can have bottom surfaces with any number of recesses and the mounts can have any number of projections with engagement portions for suitable attachment between the containers and the mounts. In one embodiment, the number of projections can be different than the number of recesses in the bottom surfaces of the containers.

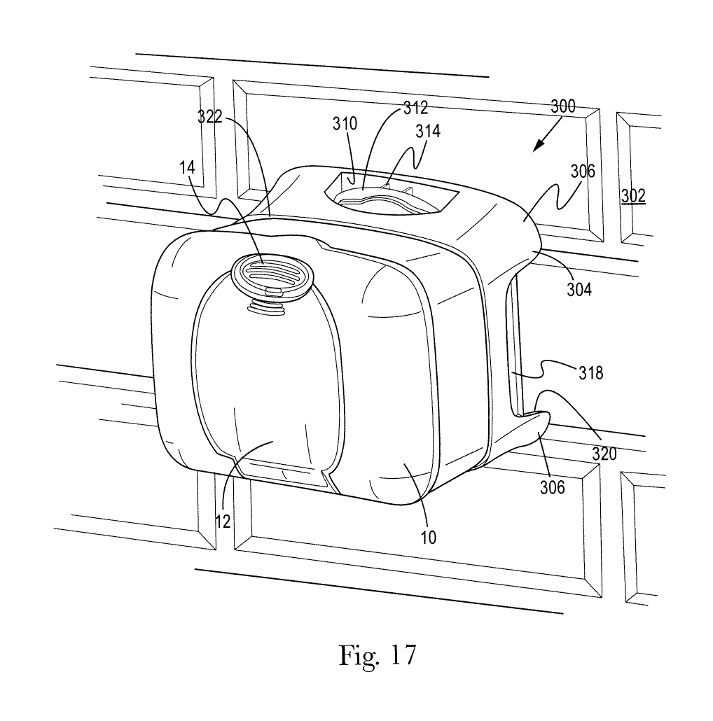

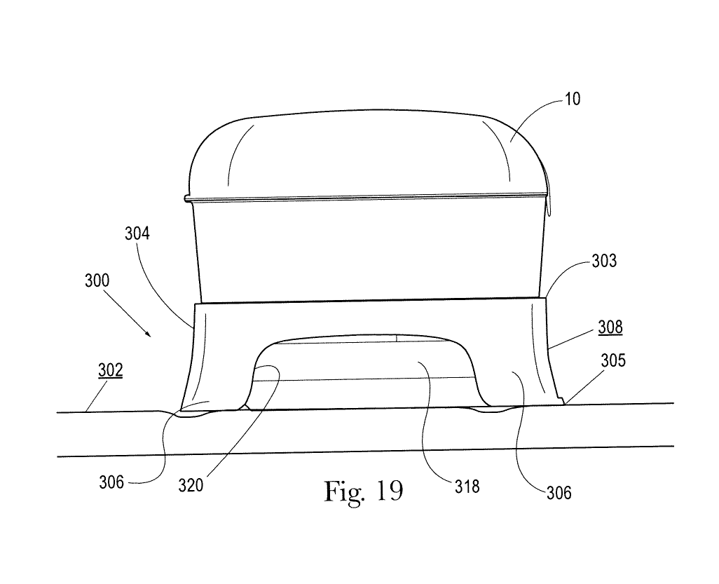

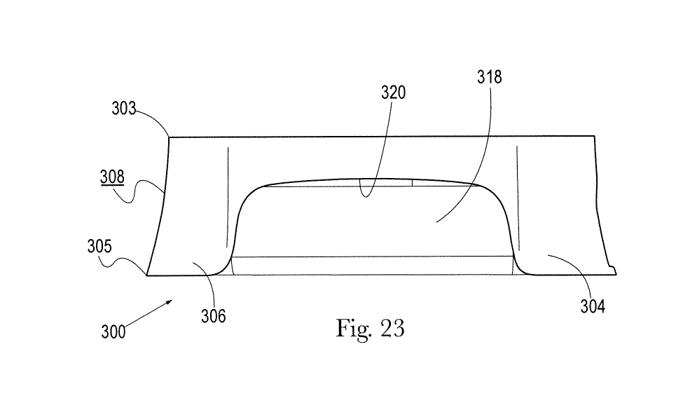

In one embodiment, referring to FIGS. 17-23, another mount 300 is provided. The mount 300 can be configured to be engaged with a container of wet wipes or other items and hold the container 10 on a surface 302, such as a wall or countertop, for example. The container 10 can be engaged with the mount 300 prior to or after the mount 300 is attached to the surface 302. The container can be same as or similar to the container 10, for example, and can comprise the door 12 and the button 14. The mount 300 can comprise a base 304. The base 304 can comprise a top end 303 and a bottom end 305. An arcuate surface 308 can extend between the top end 303 and the bottom end 305. The base 304 can comprise a foot or one or more feet 306 configured to engage the surface 302. The feet 306 can be located on corners or corner areas of the base 304. The feet 306 can be provided to ensure that the mount 300 is solid when attached to the surface 302. The feet 306 can be attached to the surface 302 using adhesives, adhesive strips, and/or other fasteners. In other embodiments, the feet 306, or another portion of the base 30, can be engaged with or formed with a hanger and the hanger can be hung from a hook, a towel ring or bar, a portion of a toilet, a portion of a vanity, a vanity door, and/or a door, for example. In such an embodiment, at least some of the feet 306 can rest against the surface 302 to provide support to the mount 300 and the container 10 when the container 10 is engaged with the mount 300.

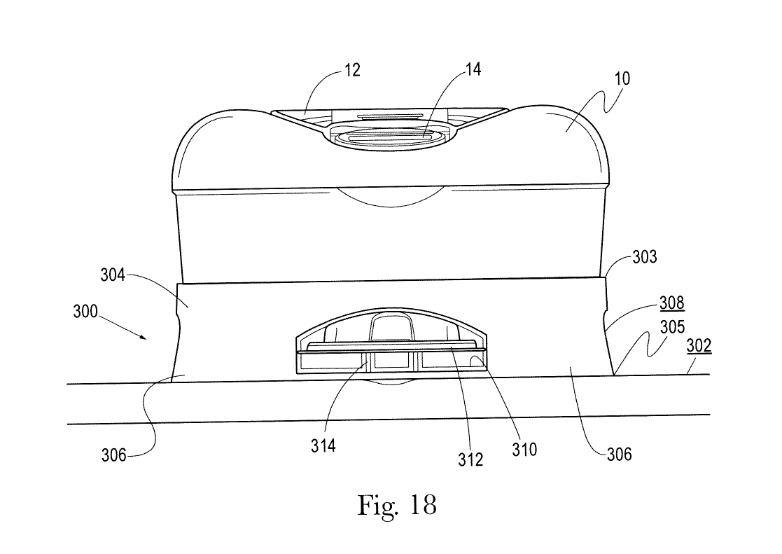

In one embodiment, the base 304 can have a slot 310 defined therein. The slot 310 can be defined in the arcuate surface 308. The slot 310 can be configured to receive at least a portion of, or all of, one or more fragrance packets 312. Each of the fragrance packets 312 can be the same as, or similar to, the fragrance packets described herein. The fragrance packet 312 can be exposed to an environment of the mount/container 300/10 so that the fragrance emitted by the fragrance packet 312 can be distributed into the environment. Stated another way, the mount 300 can be configured so that air can flow through it, thereby distributing the fragrance into the environment. In one embodiment, as illustrated in FIG. 18, the fragrance packet 312 can have an arcuate top surface that engages an arcuate top surface of the slot 310. In other embodiments, the surfaces forming the slot 310 and the fragrance packet 312 can have interlocking features to retain the fragrance packet 312 therein. The fragrance packet 312 can be sold with the mount, the container, or sold separately. In various embodiments, a surface of the slot 310 can have one or more ramped portions 314 (see e.g., FIGS. 17, 18, 20, and 21) configured to be engaged with a portion of the fragrance packet 312. As the fragrance packet 312 is pushed into the slot 310, the bottom surface, or another surface, of the fragrance packet 312 can engage the ramped portions 314, thereby sandwiching at least a portion of the fragrance packet 312 intermediate the ramped portions 314 and the top surface of the slot 310. The ramped portions 314 can also be at any other suitable location in the slot 310. The fragrance packet 312 can also be engaged with the slot 310 in any other suitable fashion, such as through the use of adhesives or merely by positioning the fragrance packet 312 at least partially, or fully, within the slot 310. The slot 310 can be located in any suitable portion of the base 304. The fragrance packet 312 may or may not be visible once positioned within with the slot 310.

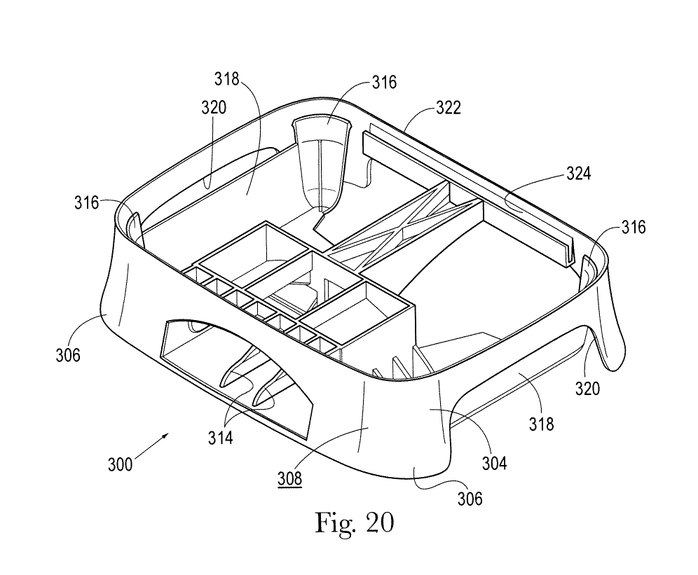

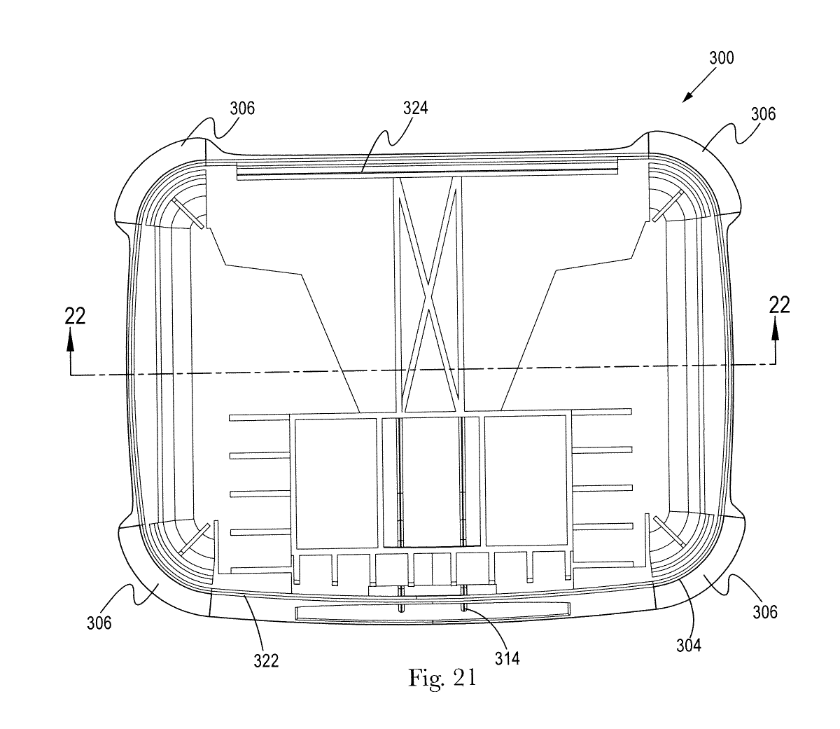

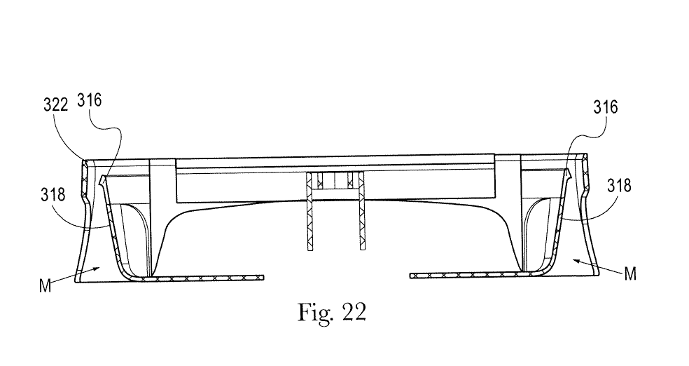

In one embodiment, referring to FIGS. 20-23, the base 304 can comprise one or more tabs 316, such as four tabs, configured to be engaged with recesses or apertures in a portion of the container 10, similar to that described above. The tabs 316 can have any or all of the features as the tabs 32 described above. The tabs 316 may be movably attached to the base 304 such that they can move toward and away from recesses or apertures in the container 10 during engagement and disengagement. In one embodiment, each tab 316 or each two tabs 316 can extend from a release portion 318 of the base 304. The release portions 318 can be accessible to a user through an opening 320 in the base 304. In one embodiment, a first release portion 318 may be provided in a first end of the base 304 and a second release portion 318 may be provided on a second end of the base 304. In such an embodiment, the release portions 318 can each be engaged with two tabs 316. As such, if the container 10 is engaged with the mount 300, the release portions 318 can be depressed by a user and move in a direction of arrows M of FIG. 22 to release the tabs 316 from the recesses or apertures in a portion of the container 10.

In one embodiment, the base 304 can comprise a flange 322 extending about, or partially about, its perimeter. The flange 322 can surround, or at least partially surround, a portion of the container 10 when the container 10 is engaged with the mount 300. The flange 322 can help a user align the container 10 with the mount 300. A portion of the base 304 proximate to the flange 322 can have a receiving slot 324 configured to receive a portion of a wall (e.g., 16) of the container 10. The receiving slot 322 can extend about an internal perimeter of the base 304 or only portions thereof. The receiving slot 324 can help a user align the container 10 with the mount 300 and prevent, or at least inhibit, the container 10 from being pushed too far into the mount 300. In one embodiment, the base 304 can have an engagement member (not illustrated) extending therefrom. The engagement member can be configured to engage an indent or a recess in a recess bottom surface of a container, such as the recessed bottom surface 22. The combination of the engagement member and the indent or recess can help a user align the container with the mount 300.

In various embodiments, the mount 300, one or more of the containers 10, and one or more of the fragrance packets 312 can be sold as a kit or sold separately. In one embodiment, the mount 300 and one or more fragrance packets 312 can be sold together, while the containers 10 may be sold separately. The mounts 300 can have indicia, branding information, directions, and/or other written or graphical materials therein, printed thereon, and/or stickered thereon.

The containers and mounts of the present disclosure can be comprised of, formed of, and/or coated with any suitable material, such as plastic, anti-microbial materials, or anti-bacterial materials, for example. In other various embodiments, the containers can be configured to dispense anti-microbial lotions or soaps, anti-bacterial lotions or soaps, liquids, and/or other compounds, for example.

The mounts of the present disclosure can also be used with containers configured to provide or dispense warmed or heated wet wipes. Such containers are disclosed in U.S. Patent Publication No. 2010/0032443, filed on Aug. 6, 2009, entitled “Dispenser for Providing Warm Wipes.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications may be made without departing from the spirit and scope of the invention. It is therefore intended to cover in the appended claims all such changes and modifications that are within the scope of this disclosure.

1. A mount for a container, wherein the container comprises a recessed bottom surface at least partially surrounded by a wall extending therefrom, and wherein the wall comprises a projection extending therefrom in a direction transverse to a plane of a side of the wall, the mount comprising:
a base; and
a tab extending from the base, wherein the tab is configured to be positioned at least partially intermediate the projection and the recessed bottom surface to retain the mount to the container.

2. The mount of claim 1, wherein a recess is defined in the wall at least partially intermediate the projection and the recessed bottom surface, and wherein the tab is configured to engage at least a portion of the recess to retain the mount to the container.

3. The mount of claim 1, wherein the base comprises any of a fastener aperture, a fastener knock-out, and an adhesive.

4. The mount of claim 3, wherein the base comprises a portion that is raised relative to a normal plane of the base, and wherein any of the fastener aperture, the fastener knock-out, and the adhesive is positioned on the portion.

5. The mount of claim 1, comprising a bracket extending from the base in a direction generally perpendicular to a normal plane of the base.

6. The mount of claim 5, wherein the bracket comprises any of a fastener aperture, a fastener knockout, and an adhesive.

7. The mount of claim 5, wherein the bracket comprises a rib extending outwardly therefrom, and wherein the base comprises a rib extending outwardly therefrom.

8. The mount of claim 1, wherein the base comprises an engagement member extending therefrom, and wherein the engagement member is configured to at least partially engage a recess in the recessed bottom surface of the container when the mount is retained to the container.

9. The mount of claim 1, wherein the base is engaged with a fragrance packet.

10. The mount of claim 9, wherein the base comprises a sleeve configured to at least partially receive the fragrance packet.

11. The mount of claim 1, comprising a spacer attached to the base, wherein the spacer comprises a side wall defining any of a recess and an aperture therein.

12. (canceled)

13. (canceled)

14. (canceled)

15. (canceled)

16. (canceled)

17. (canceled)

18. A mount for a container, wherein the container comprises a recessed bottom surface at least partially surrounded by a wall extending therefrom, and wherein the wall comprises a projection extending therefrom, the mount comprising:
a base comprising a fragrance packet;
a tab extending from the base, wherein the tab is configured to be positioned at least partially intermediate the projection and the recessed bottom surface to retain the mount to the container; and
a spacer engaged with any of the container and the base, wherein the spacer comprises a portion having any of a recess and an aperture defined therein.

19. The mount of claim 18, wherein the spacer comprises a side wall, and wherein any of the recess and the aperture is defined in the side wall.

20. The mount of claim 18, wherein the spacer at least partially surrounds the wall of the container at least when the mount is retained to the container.

21. (canceled)

22. (canceled)

23. (canceled)

24. (canceled)

25. (canceled)

26. (canceled)

27. A mount for a container, the mount comprising:
a base comprising:
one or more feet configured to engage a surface;
a tab configured to engage a portion of the container; and
a release portion configured to cause the one or more tabs to release from the container.

28. The mount of claim 27, wherein the base comprises a flange, and wherein the flange is configured to at least partially surround the container when the container is positioned on the mount.

29. The mount of claim 27, wherein a receiving slot is defined in the base, and wherein the slot is configured to receive a fragrance packet.

30. The mount of claim 29, comprising two ramped portions extending into the slot and configured to engage the fragrance packet.

31. The mount of claim 29, wherein the base comprises:
a top end;
a bottom end; and
an arcuate surface extending between the top end and the bottom end.

32. The mount of claim 31, wherein the slot is formed in the arcuate surface.
